(19) United States
(12) Patent Application Publication
(10) Pub. No.: US 2020/0172651 A1
(43) Pub. Date: Jun. 4, 2020

(54) RELEASE AGENT FOR REACTIVE HOT MELT RESIN

(71) Applicant: DIC Corporation, Tokyo (JP)

(72) Inventors: Yukie SAITOU, Osaka (JP); Atsushi NINOMIYA, Osaka (JP); Toyokuni FUJIWARA, Osaka (JP)

(21) Appl. No.: 16/631,757

(22) PCT Filed: Jun. 19, 2018
(86) PCT No.: PCT/JP2018/023233

§ 371 Date: Jan. 16, 2020

(30) Foreign Application Priority Data
Jul. 20, 2017 (JP) 2017-140842

(51) Int. Cl. C08G 18/08; C08G 18/12; C08G 18/48; C08G 18/42; C08G 18/62; C08G 18/40; C08G 18/76; C09J 7/35; C09J 7/40

(52) U.S. Cl. CPC C08G 18/0857; C08G 18/12; C08G 18/4825; C08G 18/4238; C08G 18/4222; C08G 18/4202; C09J 2475/00; C08G 18/4063; C08G 18/7671; C08G 18/0852; C09J 7/35; C09J 7/401; C08G 18/6254

(57) ABSTRACT

The present invention provides a release agent for a reactive hot melt resin, wherein a dispersion term (δD) in the Hansen solubility parameters falls within the range of 14.0 to 21.0 MPa^{0.5}, a dipole interaction force term (δP) falls within the range of 0 to 10.5 MPa^{0.5}, and a hydrogen bond term (δH) falls within the range of 0 to 13.5 MPa^{0.5}. Preferably, the adhesive for a reactive hot melt resin is at least one type of solvent selected from a group consisting of benzoic acid esters, tetrahydrofurfuryl alcohol, and tetrahydrofurfuryl (meth)acrylate. The reactive hot melt resin preferably contains an urethane prepolymer having an isocyanate group, and the urethane bond content in the urethane prepolymer is preferably within the range of 0.1 to 3 mol/kg.

### TECHNICAL FIELD

The present invention relates to a release agent used for a reactive hot melt resin.

### BACKGROUND ART

Adhesives composed of reactive hot melt resins are solventless and, therefore, have been widely used as eco-friendly adhesives in industry, and various researches centering fiber bonding and building material lamination have been performed until now.

In recent years, regarding bonding of optical components, in accordance with an increase in needs for weight reduction and film-thickness reduction of optical components, substitution of hot melt adhesives for acrylic tackifiers that are the mainstream has been studied.

Regarding the above-described adhesive, for example, an adhesive by using a moist-heat-resistant hot melt adhesive composition in which (a) 100 parts by weight of polyurethane resin having a flow starting temperature of 55° C. or higher and 110° C. or lower is mixed with (b) 5 to 150 parts by weight of saturated polyester resin having a Tg of 0° C. or higher and 110° C. or lower and a molecular weight of 10,000 to 25,000, (c) 10 to 150 parts by weight of epoxy resin having a softening temperature of 60° C. or higher and 140° C. or lower and a molecular weight of 700 to 3,000, and (d) 10 to 200 parts by weight of inorganic filler surface-treated with a coupling agent has been disclosed (refer to, for example, PTL 1).

A multilayer body obtained by using the above-described adhesive has high adhesion strength and, therefore, has an advantageous effect on adhesiveness. However, on the other hand, release is difficult. Therefore, there is a problem in that a base member is difficult to rework. In particular, recently, the reactive hot melt adhesives are frequently used for bonding optical components, and in many cases, expensive adherends (base members), for example, display portions of liquid crystal panels and cabinets, are used. Therefore, an improvement of reworkability of the base material based on releasing the adhesive has been intensely required.

### CITATION LIST

### Patent Literature

PTL 1: Japanese Unexamined Patent Application Publication No. 2003-27030

### SUMMARY OF INVENTION

### Technical Problem

An issue to be addressed by the present invention is to provide a release agent for reactive hot melt resin that has excellent capability to release a reactive hot melt resin from an adherend.

### Solution to Problem

The present invention provides a release agent for a reactive hot melt resin, wherein a dispersion term (δD) in the Hansen solubility parameters falls within the range of 14.0 to 21.0 MPa^{0.5}, a polarization term (δP) falls within the range of 0 to 10.5 MPa^{0.5}, and a hydrogen bond term (δH) falls within the range of 0 to 13.5 MPa^{0.5}.

### Advantageous Effects of Invention

The release agent for a reactive hot melt resin according to the present invention can provide excellent releasability between an adhesive layer obtained by using the reactive hot melt resin and the adherend. In addition, since the base member bonded by the adhesive layer can be thereby separated, excellent reworkability of the base member is ensured.

### DESCRIPTION OF EMBODIMENTS

Regarding the release agent for a reactive hot melt resin according to the present invention, it is necessary that the dispersion term (δD) in the Hansen solubility parameters fall within the range of 14.0 to 21.0 MPa^{0.5}, the polarization term (δP) fall within the range of 0 to 10.5 MPa^{0.5}, and the hydrogen bond term (δH) fall within the range of 0 to 13.5 MPa^{0.5}. The reactive hot melt resin that is the target of releasing is solid at room temperature and is melted by heating, and regarding the value of the dispersion term in the Hansen solubility parameters, usually, the dispersion term (δD) falls within the range of 14.0 to 21.0 MPa^{0.5}, the polarization term (δP) falls within the range of 0 to 10.5 MPa^{0.5}, and a hydrogen bond term (δH) falls within the range of 0 to 13.5 MPa^{0.5}. Consequently, since the dispersion term (δD) of the release agent falls within the range of 14.0 to 21.0 MPa^{0.5}, the polarization term (δP) falls within the range of 0 to 10.5 MPa^{0.5}, and the hydrogen bond term (δH) falls within the range of 0 to 13.5 MPa^{0.5}, the release agent has favorable affinity for the reactive hot melt resin. Therefore, appropriate swelling property and solubility are obtained and excellent releasability can be obtained. In this regard, the release agent for a reactive hot melt resin according to the present invention can simply release the reactive hot melt resin from the base member without performing further processing such as heating, and provides, for example, excellent reworkability to the base member since dissolution-erosion of the base member does not occur.

In this regard, the Hansen solubility parameters denote the solubility parameter introduced by Hildebrand being divided into three components, that is, the dispersion term (δD), the polarization term (δP), and the hydrogen bond term (δH), and being expressed in a three-dimensional space. The dispersion term (δD) indicates an effect of a dispersion force, the polarization term (δP) indicates an effect of a dipole interaction force, and the hydrogen bond term (δH) indicates an effect of a hydrogen bonding force.

The definition and the calculation of the Hansen solubility parameters are described in Charles M. Hansen, “Hansen Solubility Parameters; A Users Handbook (CRC Press, 2007)”. In addition, regarding even an organic solvent with a parameter value not described in literature, the Hansen solubility parameters can be estimated on the basis of the chemical structure by using computer software “Hansen Solubility Parameters in Practice (HSPiP)”. In the present invention, regarding solvents with parameter values described in literature, the described values are used, and regarding organic solvent with parameter values not described in literature, parameter values estimated by using HSPiP version 4.1.06 are used.

Regarding the release agent for a reactive hot melt resin according to the present invention, one type of solvent may be used, or at least two types of solvents may be used in combination. In the case in which at least two types are used in combination, solvents to be used may be combined such that, regarding each of the three parameters of the Hansen solubility parameters, the weighted average value of the respective values of the solvents falls within the above-described range.

The dispersion term (δD) in the Hansen solubility parameters falls more preferably within the range of 16.5 to 19.0 MPa^{0.5} from the viewpoint of obtaining releasability with more excellent compatibility. The polarization term (δP) falls more preferably within the range of 4.5 to 9.0 MPa^{0.5} from the viewpoint of obtaining releasability with more excellent wettability. Further, the hydrogen bond term (δH) falls more preferably within the range of 3 to 13.0 MPa^{0.5} from the viewpoint of obtaining releasability with more excellent solubility.

Specific examples of the release agent for a reactive hot melt resin include benzoic acid esters such as methyl benzoate (dispersion term (δD): 18.9, polarization term (δP): 8.2, and hydrogen bond term (δH): 4.7), ethyl benzoate (dispersion term (δD): 17.9, polarization term (δP): 6.2, and hydrogen bond term (δH): 6.0), butyl benzoate (dispersion term (δD): 18.3, polarization term (δP): 5.6, and hydrogen bond term (δH): 5.5), hexyl benzoate (dispersion term (δD): 17.2, polarization term (δP): 4.9, and hydrogen bond term (δH): 3.4), benzoic acid diethylene glycol ester (Hansen solubility parameters: dispersion term (δD): 17.6, polarization term (δP): 9.0, and hydrogen bond term (δH): 4.8), and benzoic acid dipropylene glycol ester (dispersion term (δD): 17.5, polarization term (δP): 8.0, and hydrogen bond term (δH): 4.0); tetrahydrofurfuryl alcohol (dispersion term (δD): 17.8, polarization term (δP): 8.2, and hydrogen bond term (δH): 12.9), tetrahydrofurfuryl acrylate (dispersion term (δD): 16.9, polarization term (δP): 5.9, and hydrogen bond term (δH): 6.5), and tetrahydro methacrylate (dispersion term (δD): 16.8, polarization term (δP): 5.2, and hydrogen bond term (δH): 5.7)

Of these, it is preferable that at least one type of solvent selected from a group consisting of benzoic acid esters, tetrahydrofurfuryl alcohol, and tetrahydrofurfuryl (meth)acrylate be used as the release agent for a reactive hot melt resin since releasing is facilitated because of becoming compatible while the strength of the reactive hot melt resin coating is maintained.

Examples of the reactive hot melt resin include polyester resins, modified olefin resins, and moisture-curable hot melt resin containing an urethane prepolymer having an isocyanate group. According to the release agent of the present invention, favorable releasability can be provided to the reactive hot melt resins.

For example, a product obtained by reacting a polyol with a polyisocyanate may be used as the urethane prepolymer having an isocyanate group that is used for the moisture-curable hot melt resin. In addition, these may be further reacted with a compound having a (meth)acryloyl group so as to be provided with active-energy-line curability.

Examples of the polyol include polyether polyols, polyester polyols, acryl polyols, polycarbonate polyols, polybutadiene polyols, and dimer diols.

The number average molecular weight of the polyol is preferably within the range of 500 to 50,000 and more preferably 700 to 10,000 from the viewpoint of obtaining favorable adhesiveness and mechanical strength. In this regard, the number average molecular weight of the polyether polyol is indicated by a value measured by using gel-permeation-chromatography (GPC).

Examples of the polyisocyanate include aromatic polyisocyanates such as polymethylene polyphenyl polyisocyanate, diphenylmethane diisocyanate, carbodiimide-modified diphenylmethane diisocyanate, phenylene diisocyanate, tolylene diisocyanate, and naphthalene diisocyanate, and aliphatic or alicyclic polyisocyanates such as hexamethylene diisocyanate, lysine diisocyanate, cyclohexane diisocyanate, isophorone diisocyanate, dicyclohexylmethane diisocyanate, xylylene diisocyanate, and tetramethylxylylene diisocyanate. Of these, it is particularly preferable that diphenylmethane diisocyanate be used from the viewpoint of reactivity and adhesiveness.

The urethane prepolymer is produced by reacting the polyol with the polyisocyanate and has, at a polymer end or in the molecule, an isocyanate group that can form a cross-linking structure by reacting with moisture present in air or in a cabinet or adherend which is coated with the urethane prepolymer.

Regarding the method for manufacturing the urethane prepolymer, for example, a manufacturing method in which a mixture of the polyol is dropped into a reaction container including the polyisocyanate and, thereafter, heating is performed so as to cause a reaction under the condition that the isocyanate group in the polyisocyanate is excessive relative to the hydroxy group in the polyol may be used.

When the urethane prepolymer is produced, the equivalence ratio of the isocyanate group in the polyisocyanate to the hydroxy group in the polyol ([isocyanate group/hydroxy group]) falls preferably within the range of 1.1 to 5 and more preferably within the range of 1.5 to 3 from the viewpoint of adhesiveness and mechanical strength.

When the urethane prepolymer is produced, an urethanization catalyst may be used as the situation demands. The urethanization catalyst may be appropriately added at any stage of the reaction.

Examples of the urethanization catalyst include nitrogen-containing compounds such as triethylamine, triethylenediamine, and N-methylmorpholine; metal salts such as potassium acetate, zinc stearate, and tin octylate; and organometallic compounds such as dibutyltin dilaurate.

The amount of urethane bond in the urethane prepolymer obtained by the above-described method is preferably within the range of 0.1 to 3 mol/kg and more preferably within the range of 0.2 to 2 mol/kg from the viewpoint that favorable affinity for the release agent according to the present invention is provided and more excellent adhesiveness and releasability are obtained. In this regard, the amount of urethane bond in the urethane prepolymer is indicated by the value calculated from the amount of the urethane prepolymer raw material used.

The isocyanate group content (hereafter abbreviated as “NCO %”) in the urethane prepolymer is preferably within the range of 1.5% to 8% by mass, more preferably within the range of 1.7% to 5% by mass, and particularly preferably within the range of 1.8% to 3% by mass from the viewpoint that more favorable adhesiveness and releasability are obtained. In this regard, the NCO % in the urethane prepolymer is indicated by the value measured by using a potentiometric titration method in conformity with JIS K 1603-1:2007.

Regarding the viscosity of the urethane prepolymer, the melt viscosity at 110° C. is preferably within the range of 1,000 to 50,000 mPa·s and more preferably within the range of 2,000 to 10,000 mPa·s. In this regard, the melt viscosity at 110° C. is indicated by the value measured by using an ICI cone plate viscometer.

Examples of the compound having a (meth)acryloyl group that can be reacted in the case in which active-energy-line curability is provided to the urethane prepolymer include (meth)acrylic acid alkyl esters having a hydroxy group, such as 2-hydroxyethyl (meth)acrylate, 2-hydroxypropyl (meth)acrylate, 3-hydroxypropyl acrylate, 3-hydroxybutyl (meth)acrylate, 4-hydroxybutyl (meth)acrylate, 6-hydroxyhexyl acrylate, and hydroxyethyl acrylamide; polyfunctional (meth)acrylates having a hydroxy group, such as trimethylolpropane di(meth)acrylate, pentaerythritol tri(meth)acrylate, and dipentaerythritol penta(meth)acrylate; polyethylene glycol monoacrylate, polypropylene glycol monoacrylate; and (meth)acrylic compounds having an isocyanate group, such as 2-(meth)acryloyloxyethylisocyanate, 2-(2-(meth)acryloyloxyethyloxy)ethylisocyanate, and 1,1-bis(meth)acryloyloxymethyl)ethylisocyanate.

The moisture-curable hot melt resin containing an urethane prepolymer having an isocyanate group may be composed of the urethane prepolymer only but may contain other additives, as the situation demands.

Examples of the other additives include curing catalysts, antioxidants, tackifiers, plasticizers, stabilizers, fillers, dyes, pigments, fluorescent brighteners, silane coupling agents, and waxes.

Preferable examples of applications for which the reactive hot melt resin is used include fiber bonding, building material lamination, and bonding of optical components.

Examples of the aspect of application to the bonding of optical components include sealants for cellular phones, personal computers, game consoles, televisions, car navigation systems, camera speakers, electric reels of fishing tackle, and the like.

When the bonding is performed, for example, a method in which the reactive hot melt resin is heat-melted in a temperature range of 50° C. to 130° C., one base member is coated with the resulting composition, and the other base member is bonded to the resulting resin layer so as to obtain a multilayer body is adopted.

Examples of the base member include glass plates, metal plates of stainless steel (SUS), magnesium, aluminum, and the like, and materials produced from cycloolefin resins such as norbornene, acrylic resins, urethane resins, silicon resins, epoxy resins, fluororesins, polystyrene resins, polyester resins, polysulfone resins, polyarylate resins, polyvinyl chloride resins, polyvinylidene chlorides, polyolefin resins, polyimide resins, alicyclic polyimide resins, polyamide resins, cellulose resins, polycarbonates (PC), polybutylene terephthalates (PBT), polyphenylene ethers (modified PPE), polyethylene naphthalates (PEN), polyethylene terephthalates (PET), lactic acid polymers, acrylonitrile-butadiene-styrene copolymers (ABS), acrylonitrile-styrene copolymers (AS), and the like. The base members may be subjected to corona treatment, plasma treatment, primer treatment, or the like, as the situation demands.

Regarding the method for coating the base member with the reactive hot melt resin, for example, roll coaters, spray coaters, T-tie coaters, knife coaters, and comma coaters may be used. Meanwhile, since the reactive hot melt resin has low viscosity, shape retainability after coating, and the like, coating may be performed by a method of dispensing, ink-jet printing, screen printing, offset printing, or the like. According to these coating methods, the reactive hot melt resin can be applied to a predetermined coating place on the member favorably because a loss due to stamping and the like can be suppressed. In addition, according to these coating method, the reactive hot melt resin can be continuously or intermittently formed into various shapes of point, line, triangle, quadrangle, circle, curve, and the like on the base member.

The thickness of the cured material layer of the reactive hot melt resin may be set in accordance with the use and may be set to be preferably within the range of, for example, 10 μm to 5 mm.

The condition for aging after the bonding may be appropriately determined within the range of, for example, the temperature of 20° C. to 80° C., the relative humidity of 50% to 90% RH, and 0.5 to 5 days.

According to the above-described method, a multilayer body including at least two layers of the base member and the reactive hot melt adhesive layer that are firmly bonded to each other is obtained. Examples of the method for releasing the reactive hot melt adhesive layer from the multilayer body so as to recover the base member include a method in which the multilayer body is dipped into the release agent for a reactive hot melt resin according to the present invention; and a method in which the reactive hot melt adhesive layer of the multilayer body is subjected to coating or wiping by using a cotton swab, paper, cloth, or the like.

As described above, the release agent for a reactive hot melt resin according to the present invention can provide excellent releasability between the adherend and the adhesive layer obtained by using the reactive hot melt resin. In addition, since the base member bonded by the adhesive layer can be thereby separated, excellent reworkability of the base member is ensured.

### EXAMPLES

The present invention will be described below in more detail with reference to the examples.

### Synthesis Example 1

<Synthesis of Urethane Prepolymer (1)>

After 15 parts by mass of polypropylene glycol (number average molecular weight: 1,000), 15 parts by mass of polypropylene glycol (number average molecular weight: 2,000), 10 parts by mass of crystalline polyester polyol (reaction product of 1,6-hexane diol and adipic acid, number average molecular weight: 2,000), 10 parts by mass of crystalline polyester polyol (reaction product of 1,6-hexane diol and 1,12-dodecane dicarboxylic acid, number average molecular weight: 3,500), 15 parts by mass of crystalline polyester polyol (bisphenol A propylene oxide 6-mol adduct, reaction product of sebasic acid and isophthalic acid, number average molecular weight: 2,000), and 2.5 parts by mass of acryl polyol (reaction product based on butyl acrylate/methyl methacrylate/ethyl acrylate/2-hydroxyethyl methacrylate=69.65/25/5/0.35 (mass ratio), number average molecular weight: 13,000, and glass transition temperature: −30.3° C.), were placed into a four-neck flask provided with a thermometer, an agitator, an inert gas inlet, and a reflux condenser, dehydration was performed under the condition of reduced pressure until the water content became 0.05% by mass or less.

Subsequently, cooling to the temperature in the container of 70° C. was performed. Thereafter, 16.5 parts by mass of 4,4′-diphenylmethane diisocyanate was added, the temperature was increased to 100° C., and the reaction was performed for about 3 hours until the isocyanate group content became constant so as to obtain urethane prepolymer (1) having an isocyanate group. Regarding the resulting urethane prepolymer (1), the dispersion term (δD) was 17.7, the polarization term (δP) was 5.6, and the hydrogen bond term (δH) was 5.3. In addition, the urethane bond content in urethane prepolymer (1) was 0.90 mol/kg.

In this regard, the number average molecular weight of the polyol used in the synthesis example is indicated by a value measured by using gel-permeation-chromatography (GPC) under the following conditions.

Measurement apparatus: High Performance GPC System (“HLC-8220 GPC” produced by Tosoh Corporation)

Column: the following columns produced by Tosoh Corporation were used while being connected in series

“TSKgel G5000” (7.8 mm I.D.×30 cm) 1 unit

“TSKgel G4000” (7.8 mm I.D.×30 cm) 1 unit

“TSKgel G3000” (7.8 mm I.D.×30 cm) 1 unit

“TSKgel G2000” (7.8 mm I.D.×30 cm) 1 unit

Detector: RI (differential refractometer)

Column temperature: 40° C.

Eluent: tetrahydrofuran (THF)

Flow rate: 1.0 mL/min

Amount of injection: 100 μL (tetrahydrofuran solution with a sample concentration of 0.4% by mass)

Standard sample: a calibration curve was formed by using standard polystyrenes described below

(Standard Polystyrenes)

“TSKgel Standard polystyrene A-500” produced by Tosoh Corporation

“TSKgel Standard polystyrene A-1000” produced by Tosoh Corporation

“TSKgel Standard polystyrene A-2500” produced by Tosoh Corporation

“TSKgel Standard polystyrene A-5000” produced by Tosoh Corporation

“TSKgel Standard polystyrene F-1” produced by Tosoh Corporation

“TSKgel Standard polystyrene F-2” produced by Tosoh Corporation

“TSKgel Standard polystyrene F-4” produced by Tosoh Corporation

“TSKgel Standard polystyrene F-10” produced by Tosoh Corporation

“TSKgel Standard polystyrene F-20” produced by Tosoh Corporation

“TSKgel Standard polystyrene F-40” produced by Tosoh Corporation

“TSKgel Standard polystyrene F-80” produced by Tosoh Corporation

“TSKgel Standard polystyrene F-128” produced by Tosoh Corporation

“TSKgel Standard polystyrene F-288” produced by Tosoh Corporation

“TSKgel Standard polystyrene F-550” produced by Tosoh Corporation

[Production of Multilayer Body]

Urethane prepolymer (1) was heat-melted at 110° C., and a straight line of 10 cm per side was applied with a thickness of 0.2 mm to a PET (polyethylene terephthalate) film (13 cm×15 cm, thickness of 50 m) at a discharge pressure of 0.3 MPa and a processing speed of 50 mm/sec by using a dispenser needle having an inner diameter of 0.4 mm (Dispenser “VAVE MASTER ME-5000VT” produced by Musashi Engineering, Inc.) heated to 110° C. A multilayer body was obtained by being left to stand for three days in a thermo-hygrostat at a temperature of 23° C. and a relative humidity of 65%.

### Example 1

The PET film/adhesive layer surface of the resulting multilayer body was coated with a release agent containing 100% by mass of tetrahydrofurfuryl alcohol by using a cotton swab and was left to stand for 5 minutes in an atmosphere at 23° C., and the end of the straight line was peeled with tweezers. Thereafter, a releasability test was performed by fixing the multilayer body to a popular digital force gauge (“DS2-200N” produced by IMADA CO., LTD.) and measuring the peel strength (N). In addition, the releasability test of the multilayer body before coating of the release agent was also performed.

### Examples 2 to 5 and Comparative Examples 1 and 2

The releasability test was performed in the same manner as example 1 except that the type of the release agent was changed as described in Tables 1 and 2.

TABLE 1

| Table 1 | | | Example 1 | Example 2 | Example 3 | Example 4 |
|---|---|---|---|---|---|---|
| Release agent | | | | | | |
| tetrahydrofurfuryl | Dispersion term (δD)[MPa^{0.5}] | 17.8 | 100 | | | |
| alcohol | Dipole interaction force term | 8.2 | | | | |
| (% by mass) | (δP)[MPa^{0.5}] | | | | | |
| | Hydrogen bond term | 12.9 | | | | |
| | (δH)[MPa^{0.5}] | | | | | |
| tetrahydrofurfuryl | Dispersion term (δD)[MPa^{0.5}] | 16.9 | | 100 | | |
| acrylate | Dipole interaction force term | 5.9 | | | | |
| (% by mass) | (δP)[MPa^{0.5}] | | | | | |
| | Hydrogen bond term | 6.5 | | | | |
| | (δH)[MPa^{0.5}] | | | | | |
| tetrahydrofurfuryl | Dispersion term (δD)[MPa^{0.5}] | 16.8 | | | 100 | |
| methacrylate | Dipole interaction force term | 5.2 | | | | |
| (% by mass) | (δP)[MPa^{0.5}] | | | | | |
| | Hydrogen bond term | 5.7 | | | | |
| | (δH)[MPa^{0.5}] | | | | | |
| butyl benzoate | Dispersion term (δD)[MPa^{0.5}] | 18.3 | | | | 100 |
| (% by mass) | Dipole interaction force term | 5.6 | | | | |
| | (δP)[MPa^{0.5}] | | | | | |
| | Hydrogenbond term | 5.5 | | | | |
| | (δH)[MPa^{0.5}] | | | | | |

| | | | | |
|---|---|---|---|---|
| Reactive hot melt resin | Urethane | Urethane | Urethane | Urethane |
| | prepolymer (1) | prepolymer (1) | prepolymer (1) | prepolymer (1) |
| Peel strength (N) | | | | |
| After release agent coating | 0.47 | 0.40 | 0.50 | 0.46 |
| Before release agent coating | 1.32 | 1.32 | 1.32 | 1.32 |

TABLE 2

| | | | | Comparative | Comparative |
|---|---|---|---|---|---|
| Release agent | | | Example 5 | example 1 | example 2 |
| hexyl | Dispersion term (δD)[MPa⁰·⁵] | 17.2 | 100 | | |
| benzoate | Dipole interaction force term (δP)[MPa⁰·⁵] | 4.9 | | | |
| (% by mass) | Hydrogen bond term (δH)[MPa⁰·⁵] | 3.4 | | | |
| benzyl | Dispersion term (δD)[MPa⁰·⁵] | 18.4 | | 100 | |
| alcohol | Dipole interaction force term (δP)[MPa⁰·⁵] | 6.3 | | | |
| (% by mass) | Hydrogen bond term (δH)[MPa⁰·⁵] | 13.7 | | | |
| water | Dispersion term (δD)[MPa⁰·⁵] | 15.5 | | | 100 |
| (% by mass) | Dipole interaction force term (δP)[MPa⁰·⁵] | 16.0 | | | |
| | Hydrogen bond term (δH)[MPa⁰·⁵] | 42.3 | | | |

| | | | |
|---|---|---|---|
| Reactive hot melt resin | Urethane | Urethane | Urethane |
| | prepolymer | prepolymer | prepolymer |
| | (1) | (1) | (1) |
| Peel strength (N) | | | |
| After release agent coating | 0.55 | 0.92 | 1.20 |
| Before release agent coating | 1.32 | 1.32 | 1.32 |

It was found that the release agent for reactive hot melt resin according to the present invention had excellent capability to release the reactive hot melt resin from the base member.

On the other hand, regarding comparative example 1 that was a germ layer using a release agent with the hydrogen bond term (δH) in the Hansen solubility parameters greater than the range specified in the present invention, the peel strength was not significantly degraded, and the releasability was insufficient.

Meanwhile, regarding comparative example 2 that was a germ layer using a release agent with the dipole interaction force term (δP) and the hydrogen bond term (δH) in the Hansen solubility parameters greater than the ranges specified in the present invention, the peel strength was not significantly degraded, and the releasability was insufficient.

1. A release agent for a reactive hot melt resin, wherein a dispersion term (δD) in the Hansen solubility parameters falls within the range of 14.0 to 21.0 MPa^{0.5}, a dipole interaction force term (δP) falls within the range of 0 to 10.5 MPa^{0.5}, and a hydrogen bond term (δH) falls within the range of 0 to 13.5 MPa^{0.5}.

2. The release agent for a reactive hot melt resin according to claim 1, wherein the release agent is at least one type of solvent selected from a group consisting of benzoic acid esters, tetrahydrofurfuryl alcohol, and tetrahydrofurfuryl (meth)acrylate.

3. The release agent for a reactive hot melt resin according to claim 1, wherein the reactive hot melt resin is a moisture-curable hot melt resin containing an urethane prepolymer having an isocyanate group.

4. The release agent for a reactive hot melt resin according to claim 3, wherein the urethane bond content in the urethane prepolymer falls within the range of 0.1 to 3 mol/kg.

5. The release agent for a reactive hot melt resin according to claim 2, wherein the reactive hot melt resin is a moisture-curable hot melt resin containing an urethane prepolymer having an isocyanate group.
